(19) United States
(12) Patent Application Publication
(10) Pub. No.: US 2007/0047095 A1
(43) Pub. Date: Mar. 1, 2007

(54) Electrowetting system with stable movement

(75) Inventors: Ha Yong Jung, Suwon (KR); Hee Sung Choi, Suwon (KR); Jin Hyuck Yang, Seoul (KR); Jae Young Bae, Suwon (KR); Jong Yun Kim, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/508,297

(22) Filed: Aug. 23, 2006

(30) Foreign Application Priority Data
Aug. 23, 2005 (KR) 10-2005-0077367

(51) Int. Cl. G02B 3/12

(52) U.S. Cl. 359/665

(57) ABSTRACT

Disclosed herein is an electrowetting system using the electrowetting phenomenon. The electrowetting system comprises an electrolyte solution consisting of 30 to 89% by weight of water, 0.01 to 30% by weight of a salt and 10 to 60% by weight of a polar solvent having a dipole moment. According to the electrowetting system, the polar solvent added to increase the viscosity of the electrolyte solution stabilizes the movement of the electrolyte solution when a voltage is applied to operate the electrowetting system. In addition, high- or low-temperature reliability of the electrowetting system can be ensured by the use of the polar solvent.

### RELATED APPLICATIONS

The present application is based on, and claims priority from, Korean Application Number 2005-77367, filed Aug. 23, 2005, the disclosure of which is incorporated by reference herein in its entirety.

### BACKGROUND OF THE INVENTION

1. Field of the Invention

The present invention relates to an electrowetting system, and more particularly to an electrowetting system using an electrically conductive solution in which a polar solvent is contained to stabilize the movement of the solution and to increase the viscosity of the solution.

2. Description of the Related Art

Electrowetting is a phenomenon wherein the surface tension of a liquid is altered using electrical charges present at the interface of the liquid. According to the electrowetting phenomenon, a high potential difference at the interface of a liquid is achieved when a thin insulator is present at the interface.

The electrowetting phenomenon can be utilized to handle microliquids and microparticles present in liquids. A great deal of research has been concentrated on products based on the electrowetting phenomenon. The electrowetting phenomenon is currently utilized in a wide variety of applications, including liquid lenses, micropumps, display devices, optical devices and micro-electromechanical systems (MEMSs). Particularly, liquid lenses for auto focus (A/F) have the advantages of small size, reduced electric power consumption and high response rate, in terms of their operational manner, compared to conventional liquid lenses.

Various factors, such as operational performance, optical performance, reproducibility, stability and reliability, must be taken into consideration in order to realize electrowetting systems. Particularly, when a voltage is applied to an electrowetting system, the shape of a liquid must be stably maintained without unstable trembling and moving at the interface of the liquid to achieve desired purposes.

The production of an electrowetting system based on the electrowetting phenomenon essentially requires the use of one or more solutions. An electrically conductive solution (hereinafter, referred to as an “electrolyte solution”) is particularly important because it possesses electrical properties and functions to substantially operate an electrowetting system. In general, an electrolyte solution contains pure water and a salt, e.g., Na₂SO₄ or LiCl, serving to impart electrical properties to the pure water. FIG. 2 shows a state in which an electrolyte solution is moved in a general electrowetting system when a voltage is applied to the electrowetting system.

The mechanism of the electrowetting phenomenon is not clearly established. Research and development have been conducted on the mechanism of the electrowetting phenomenon on the assumption that there is no change in the interfacial energy between solid/liquid phases and between liquid/gas phases. Accordingly, simple control using a potential difference was employed to operate electrowetting systems.

FIG. 1 is a cross-sectional diagram schematically showing the structure of a conventional system based on the electrowetting phenomenon. A relationship between the contact angle and the surface energy of a solid plate is generally expressed by Young's Equation:
γ_{SL}=γ_{SG}−γ_{LG} cos θ (1)

wherein γ_{SL} is the solid/liquid interfacial energy, γ_{SG} is the solid/gas interfacial energy, γ_{LG} is the liquid/gas interfacial energy, and θ is the contact angle.

A thermomechanical expression regarding an electrolyte solution present between two electrodes and a voltage applied to the electrodes is generally explained by Lippmann's Equation 2:

$$γ = {γ}_{o} - \frac{1}{2} {cV}^{2} \qquad ( 2 )$$

Equation 1 is combined with Equation 2 to give the following Equation 3, called the Lippmann-Young's Equation:

$$cos θ = cos {θ}_{0} + \frac{1}{{γ}_{LG}} \frac{1}{2} {cV}^{2} \qquad ( 3 )$$

wherein θ is the contact angle when a voltage is applied, θ₀ is the initial contact angle, c is the capacitance, and V is the applied voltage.

Modification of the Lippmann-Young's Equation gives the following Equation 4.

$$cos θ = cos {θ}_{0} - \frac{ɛ}{2 {γ}_{1} d} {V}^{2} \qquad ( 4 )$$

wherein θ is the contact angle when a voltage is applied, θ₀ is the initial contact angle, ε is the dielectric constant between the electrodes, d is the thickness of an insulator, V is the applied voltage, and γ₁ is the interfacial energy.

Charges present in an electrolyte tend to move toward the boundaries of the electrolyte in view of their chemical properties. The tendency becomes stronger when an external voltage is applied to the electrolyte. Particularly, the concentration of the charges is greatly increased at triple contact lines (TCLs) where the boundaries overlap. This phenomenon brings about an increase in the repulsive force between the charges, resulting in lowering of surface tension at the edges of liquid droplets. This is expressed by the following relationship:

$$\frac{Surface force}{Volume force} ∝ \frac{{I}^{2}}{{I}^{3}} = \frac{1}{I}$$

FIG. 2 shows a state in which an electrolyte solution, which contains pure water and a salt for imparting electrical properties to the pure water, in an electrowetting system is moved when a voltage is applied to the electrowetting system. Referring to FIG. 2, a droplet of the electrolyte solution is dropped on an insulator, which is coated on an electrode. When a voltage is applied to the electrode, charges present in the electrolyte solution migrate. This migration of the charges induces a phenomenon wherein the droplet of the electrolyte solution spreads on the surface of the insulator.

When a voltage is applied to operate the electrowetting system, it is important to maintain the electrowetting system without unstable trembling and moving of the electrolyte solution. Since general electrolyte solutions are prepared by adding a small quantity of a salt to pure water to impart electrical properties to the pure water, they have low viscosity and thus their unstable movement is inevitable.

### SUMMARY OF THE INVENTION

It is one object of the present invention to control the viscosity of an electrolyte solution constituting an electrowetting system by using a polar solvent, so that the movement of the electrolyte solution is stabilized when an operating voltage is applied to the electrowetting system.

It is another object of the present invention to control the density and surface tension of an electrolyte solution, to lower the freezing point of the electrolyte solution and to increase the boiling point of the electrolyte solution by using a polar solvent, so that superior high- and low-temperature reliability of the electrolyte solution is ensured.

According to the present invention, there is provided an electrowetting system using the electrowetting phenomenon, the system comprising an electrolyte solution consisting of 30 to 89% by weight of water, 0.01 to 30% by weight of a salt and 10 to 60% by weight of a polar solvent.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional diagram schematically showing the structure of a conventional system based on the electrowetting phenomenon;

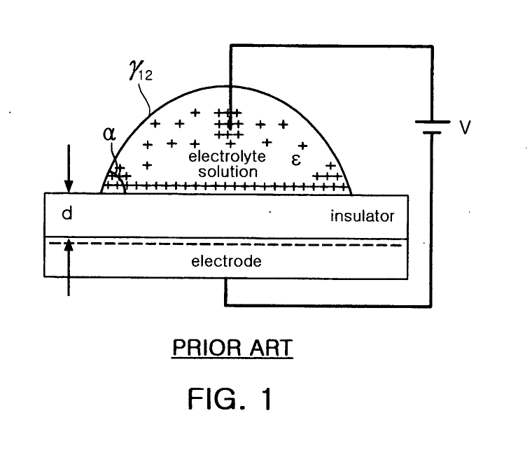

FIG. 2 is a cross-sectional diagram schematically showing a state in which an electrolyte solution is moved in a conventional electrowetting system when a voltage is applied to the electrowetting system;

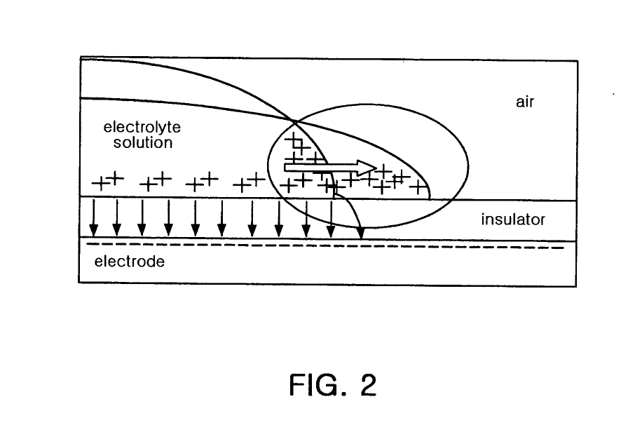

FIG. 3 shows states in which an internal solution is moved in a liquid lens as an electrowetting system when a voltage is applied to the liquid lens;

FIGS. 4a and 4b are interference patterns showing states in which an electrolyte solution is moved in a liquid lens produced in Example 1 of the present invention when operating voltages of 30 V and 50 V are applied to the liquid lens, respectively;

FIGS. 5a and 5b are interference patterns showing states in which an electrolyte solution is moved in a conventional liquid lens produced in Comparative Example 1 when no voltage is applied and an operating voltage of 30 V is applied to the liquid lens, respectively; and

FIGS. 6a and 6b are interference patterns comparing the movement of (a) an electrolyte solution in a conventional liquid lens with that of (b) an electrolyte solution in a liquid lens according to the present invention when an operating voltage (30 V) is applied to each of the liquid lenses.

### DESCRIPTION OF THE PREFERRED EMBODIMENTS

The present invention will now be described in greater detail.

The present invention provides an electrowetting system with stable movement of an electrolyte solution in which a polar solvent is contained to increase the viscosity of the electrolyte solution without unstable trembling and moving of the electrolyte solution. A liquid lens, which is a representative example of systems using the electrowetting phenomenon, will be described below.

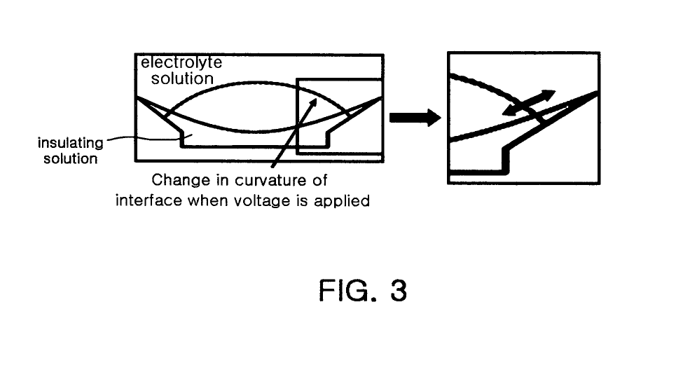

FIG. 3 shows a variable-focus liquid lens for using the electrowetting phenomenon according to one embodiment of the present invention. The variable-focus liquid lens comprises a lower electrode in the form of a plate, an insulating layer with a uniform thickness disposed on the lower electrode, an electrically insulating oil or liquid (hereinafter, referred to simply as an ‘insulating solution’) disposed on the insulating layer, and an electrolyte solution surrounding the insulating solution. An upper electrode in the form of a plate is formed in contact with the electrolyte solution. When a predetermined voltage is applied to the upper and lower electrodes, the surface tension of the electrolyte solution is varied, causing a change in the shape of the electrolyte solution. As a result, since the curvature of the insulating solution functioning as a lens is relatively changed, the focal distance of light passing through the liquid lens is varied.

The electrolyte solution is generally an electrically conductive liquid, and may contain water in an amount of 30 to 89% by weight with respect to the total weight of the electrolyte solution.

The electrolyte solution may further contain a salt for lowering the surface energy of the water and improving rheological properties. The salt is not particularly limited so long as it is generally used in the art, and examples thereof include LiCl, NH₄Cl, NaCl, KCl, NaNO₃, KNO₃, CaCl₂, KBr, MgSO₄, CuSO₄ and K₂SO₄.

The salt may be used in an amount of 0.01 to 30% by weight, based on the total weight of the electrolyte solution. Taking the electrical conductivity of the electrolyte solution into consideration, it is preferred to add the salt in the minimum amount.

The electrolyte solution used in the electrowetting system of the present invention further contains a polar solvent with a dipole moment. The polar solvent is used to increase the viscosity of the electrolyte solution. This increased viscosity allows stable movement of the electrolyte solution without unstable trembling and moving when a voltage is applied to the liquid lens.

Since general polar solvents are highly water-soluble in view of their characteristics and are immiscible with oils, they are useful in the preparation of electrolyte solutions of liquid lenses. Alcohol-based solvents having a hydroxyl (—OH) group are particularly preferred. Since alcohol-based solvents are colorless and highly transparent, they are suitable for use in lenses. In addition, since alcohol-based solvents possess a broad spectrum of physical properties, they are useful in controlling other physical properties of the electrolyte solution. The polar solvent used in the present invention acts as a surfactant, which is thus expected to achieve a reduction in operating voltage. The polar solvent may also act to inhibit mixing between the electrolyte solution and the insulating solution.

Specific examples of alcohol-based solvents suitable for use in the present invention include, but are not limited to, methanol, ethanol, 1-propanol, 2-propanol, 1,2-propanediol, 1,3-propanediol, 1,2,3-propanetriol, 1-butanol, 2-butanol, 1,2-butanediol, 1,3-butanediol 1,4-butanediol, 1-pentanol, 1,5-pentanediol, hexanol, heptanol, and octanol. These alcohol-based solvents may be used alone or in combination thereof. More preferred are ethanol, 1-propanol, 2-propanol, 1,2-propanediol, 1,2,3-propanetriol, 2-butanol, 1,3-butanediol 1,4-butanediol, 1,5-pentanediol, and mixtures thereof. The physical properties of these alcohol-based solvents are summarized in Table 1.

TABLE 1

| | | Refractive | Boiling | Freezing | Viscosity |
|---|---|---|---|---|---|
| Polar solvent | Density (g/cm³) | index (n_{D}²⁰) | point (° C.) | point (° C.) | (cP) |
| Ethanol | 0.789 | 1.360 | 78 | −114.0 | 1.2 |
| 1-Propanol | 0.804 | 1.384 | 97 | −127.0 | 2.3 |
| 2-Propanol (IPA) | 0.785 | 1.377 | 82 | −89.5 | 2.1 |
| 1,2-Propanediol | 1.036 | 1.432 | 187 | −60.0 | 40.0 |
| 1,2,3-Propanetriol | 1.25 | 1.474 | 182 | 20.0 | 800.0 |
| 2-Butanol | 0.808 | 1.397 | 98 | −115.0 | 2.8 |
| 1,3-Butanediol | 1.005 | 1.440 | 203 | −50 | 96 |
| 1,4-Pentanediol | 1.017 | 1.445 | 230 | 16 | 72.8 |
| 1,5-Pentanediol | 0.994 | 1.450 | 242 | −18 | 106.5 |

The polar solvents may be used in an amount of 10 to 60% by weight, based on the total weight of the electrolyte solution. When the electrolyte solution has a viscosity of 3 to 50 cP, it is stably moved in the system using the electrowetting phenomenon. Above 50 cP, the electrolyte solution may unfavorably inhibit the electrowetting phenomenon.

In addition to the electrolyte solution, the liquid lens comprises an insulating solution. Since the insulating solution has a predetermined viscosity, it can function as a buffer against the movement of the electrolyte solution. An optimum viscosity necessary to stabilize the movement of the electrolyte solution is in the range of 3 to 20 cP. The electrowetting system of the present invention shows little unstable trembling and moving when operated, compared to general electrowetting systems exposed to ambient air. However, in other electrowetting systems, for example, micropumps, display devices, optical devices and micro-electromechanical systems (MEMSs), comprising no insulating solution the movement of the electrolyte solution is stabilized in a higher viscosity. In these systems, the electrolyte solution is sufficiently stably moved within the viscosity range of 3 to 50 cP.

To attain the viscosity range required to stabilize the movement of the electrolyte solution when a voltage is applied to the electrowetting system, the composition of the electrolyte solution may vary depending on the kind of the polar solvent used.

Specifically, when the electrolyte solution contains 40 to 60% by weight of water, 5 to 10% by weight of the salt and 30 to 50% by weight of 1,2-propanediol as the polar solvent, it has a viscosity of 5 to 10 cP. When the electrolyte solution contains 30 to 70% by weight of water, 5 to 20% by weight of the salt and 20 to 60% by weight of 1,5-propanediol as the polar solvent, it has a viscosity of 5 to 20 cP. When the electrolyte solution contains 50 to 80% by weight of water, 5 to 15% by weight of the salt and 10 to 40% by weight of 1,4-butanediol as the polar solvent, it has a viscosity of 3 to 8 cP. An electrolyte solution having a viscosity of 3-50 cP may be prepared using at least one solvent selected from the group consisting of ethanol, 1-propanol, 2-propanol, 1,2,3-propanetriol, 2-butanol and 1,3-butanediol as the polar solvent.

Different characteristics may be required in electrolyte solutions of electrowetting systems, such as liquid lenses. For example, electrolyte solutions may be required to have density or surface tension suitable for corresponding systems. Also, electrolyte solutions may be required to have superior high- and low-temperature reliability for stable operation of corresponding systems. To this end, polar solvents can be used to control the physical properties of corresponding electrolyte solutions.

Specifically, when it is intended to achieve low-temperature reliability at −40° C. for 48 hours or more and/or high-temperature reliability at +85° C. for 96 hours or more, taking the boiling point and the freezing point of corresponding polar solvents into consideration, a suitable polar solvent, e.g., 1,2-propanediol, 1,4-butanediol or 1,5-pentanediol, is selected and used within the defined range, together with water and the salt, to prepare an electrolyte solution, thereby attaining the intended effects.

In addition to the electrolyte solution, systems based on the electrowetting phenomenon may comprise an insulating solution wherein the insulating solution is an oil and optionally contains an organic solvent. The insulating solution generally contains a silicon (Si) oil and an organic additive. Components of the insulating solution may be used within the ranges that are commonly employed in the art.

Examples of systems based on the electrowetting phenomenon include liquid lenses, micropumps, display devices, optical devices, and micro-electromechanical systems (MEMSs).

### EXAMPLES

Hereinafter, the present invention will be explained in more detail with reference to the following examples. However, these examples are given for the purpose of illustration and are not intended to limit the present invention. It will be apparent to those skilled in the art that although the following examples illustrate the production of liquid lenses, they can be applied to the production of other electrowetting systems.

### Example 1

60% by weight of pure water, 10% by weight of LiCl and 30% by weight of 1,2-propanediol were mixed together to prepare a transparent electrolyte solution with a viscosity of 6.1. 1,6-Dibromohexane was mixed with a commercially available silicon oil to prepare an insulating solution with a viscosity of 11.8.

A cell for accommodating the electrolyte solution and the insulating solution comprises an upper part and a lower part. The upper part was made of a transparent material and an internal part of the upper part was coated with a metal film, through which a voltage was applied to the electrolyte solution. The lower part of the cell was made of the same material for the upper part, an internal part of the lower part in contact with the electrolyte solution was coated with a polymer insulator, and a metal film was coated under the insulator.

The electrolyte solution and the insulating solution were introduced into the cell to complete production of a liquid lens.

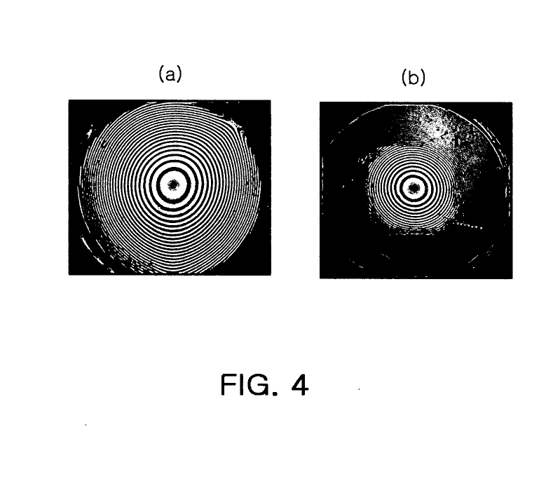

The photographs of FIGS. 4a and 4b are interference patterns showing states in which the electrolyte solution was moved in the liquid lens when 30 V and 50 V were applied to the liquid lens, respectively.

The photographs indicate that although voltages were applied to the liquid lens, which comprises the electrolyte solution whose viscosity was increased using the polar solvent, stable movement of the electrolyte solution was achieved without unstable trembling and moving.

### Comparative Example 1

90% by weight of pure water and 10% by weight of LiCl were mixed together to prepare a transparent electrolyte solution with a viscosity of 1.9. 1,6-Dibromohexane was mixed with a commercially available silicon oil to prepare an insulating solution with a viscosity of 11.8.

The electrolyte solution and the insulating solution were used to produce a liquid lens in accordance with the procedure described in Example 1.

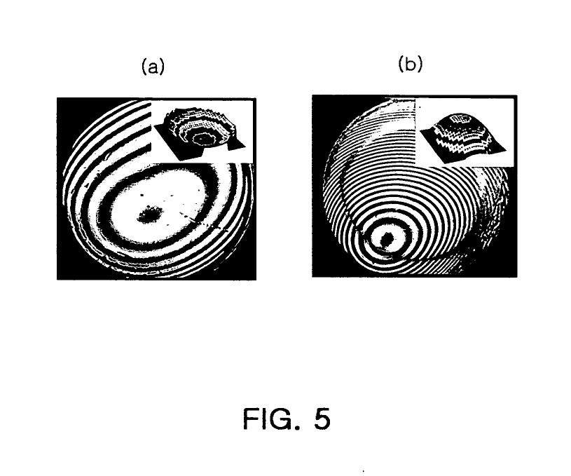

The photographs shown in FIGS. 5a and 5b are interference patterns showing states in which the electrolyte solution was moved in the liquid lens when no voltage was applied and 30 V was applied to the liquid lens, respectively.

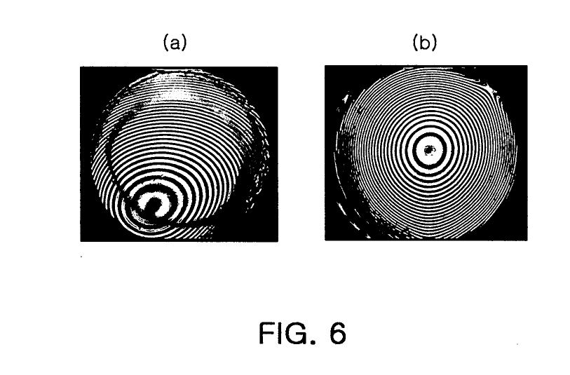

The photographs shown in FIGS. 6a and 6b are interference patterns comparing the movement of (a) the electrolyte solution containing no polar solvent with that of (b) the electrolyte solution containing the polar solvent when 30 V was applied to each of the liquid lenses.

The interference patterns of FIG. 5a indicate stable movement of the electrolyte solution without unstable trembling and moving at the interface when no voltage was applied. In contrast, the interference patterns of FIG. 5b indicate a change in the curvature of the interface between the two solutions when an external voltage of 30 V was applied to operate the liquid lens, which shows that trembling occurred at the peripheral sites during operation of the liquid lens due to the reduced viscosity of the electrolyte solution.

High voltages of 40 to 100 V are required to operate general liquid lenses. If a high voltage is applied to a liquid lens, unstable movement of an electrolyte solution becomes serious, and as a result, the role of the liquid lens cannot be adequately performed.

From the photographs of FIGS. 6a and 6b, which are interference patterns comparing the movement of a general electrolyte solution with that of the electrolyte solution in the liquid lens of the present invention when a voltage was applied, it could be confirmed that the electrolyte solution, which had increased viscosity due to the use of the polar solvent, of the liquid lens according to the present invention showed highly stable movement, compared to the general electrolyte solution.

The interference patterns of FIGS. 4a, 4b, 5a, 5b, 6a and 6b are contours showing the heights at the interfaces of the corresponding electrolyte solutions.

As apparent from the above description, according to the electrowetting system of the present invention, since a polar solvent is added to a common electrolyte solution to increase the viscosity of the electrolyte solution, unstable trembling at the interface of the electrolyte solution when a voltage is applied to the electrowetting system can be prevented. In addition, since the polar solvent contained in the electrolyte solution acts as a surfactant, the operating voltage of the electrowetting system can be reduced. Furthermore, high- or low-temperature reliability of the electrowetting system can be ensured depending on the kind of the polar solvent.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An electrowetting system using the electrowetting phenomenon, the system comprising an electrolyte solution consisting of 30 to 89% by weight of water, 0.01 to 30% by weight of a salt and 10 to 60% by weight of a polar solvent.

2. The electrowetting system according to claim 1, wherein the electrolyte solution has a viscosity of 3 to 50 cP.

3. The electrowetting system according to claim 1, wherein the electrowetting system further comprises an insulating solution and the electrolyte solution has a viscosity of 3 to 20 cP.

4. The electrowetting system according to claim 1, wherein the polar solvent is an alcohol-based solvent with a dipole moment.

5. The electrowetting system according to claim 4, wherein the alcohol-based solvent is at least one polar solvent selected from the group consisting of methanol, ethanol, 1-propanol, 2-propanol, 1,2-propanediol, 1,3-propanediol, 1,2,3-propanetriol, 1-butanol, 2-butanol, 1,2-butanediol, 1,3-butanediol 1,4-butanediol, 1-pentanol, 1,5-pentanediol, hexanol, heptanol, and octanol.
